(19) United States
(12) Patent Application Publication
(10) Pub. No.: US 2004/0076817 A1
(43) Pub. Date: Apr. 22, 2004

(54) Adhesive including a releasing agent

(76) Inventors: Michael E. Rorabaugh, Seattle, WA (US); Stacey A. Sullivan, Wichita, KS (US); Glenn A. Hopper, Augusta, KS (US)

Correspondence Address: Mark D. Elchuk, Harness, Dickey & Pierce, P.L.C., P.O. Box 828, Bloomfield Hills, MI, 48303, US

(21) Appl. No.: 10/273,797

(22) Filed: Oct. 18, 2002

(51) Int. Cl. B32B 31/00; C09J 1/00

(52) U.S. Cl. 428/320.2; 156/289; 521/76

(57) ABSTRACT

An adhesive system that allows for a strong adhesion of a member to a surface, while also allowing for easy removal of the member after a prolonged period of attachment. The member may include a structural component or a film or appliqué that is applied for other purposes. The member is affixed to a substrate with an adhesive having a releasing agent or constituent. The releasing agent allows a substantially complete removal of the member and adhesive from the substrate. Also, the adhesive may be easily removed at a desired time in the future due to the application of a particular catalyst. Thus the releasing agent permits a substantially complete removal of both the member and the adhesive which bonds the member or component to the surface.

### FIELD OF THE INVENTION

The present invention relates to releasable adhesives, and more particularly relates to an adhesive layer to bond a member to a surface which includes a releasing agent in the adhesive layer that allows the member and the adhesive layer to be easily removed from the surface.

### BACKGROUND OF THE INVENTION

Many items and films are often bonded to a substrate or surface using an adhesive. Examples of these items include appliqués, stickers, and tape. Many of these items are meant to be affixed only temporarily to the substrate. The adhesives are often so formulated as to be a temporary adhesive so that the item adhered to the surface can be easily removed in the future. Many times these adhesives, however, become tenacious or hard to remove. With time and exposure to different elements, the once weak adhesive may become tenacious and not allow the removal of the item. Also, once a difficult adhesive is removed, residue is left behind. This must also be removed before a new adhesive film is applied. Therefore, the temporary item becomes essentially permanently secured to supporting surface. In addition, the adhesive often becomes nearly impervious to solvents at this point. On the other hand, weak adhesives may not be strong enough to secure an item for the temporary period desired. Therefore, after only a short time, and before it is desired to remove the item, the item may no longer be adhered to its support surface. Additional edge sealants and the like are sometimes added to prevent premature separation initiating from the edge.

Often the environment which the item is exposed to, after being affixed to a support surface, affects the longevity of the adhesive. In particular, ultra-violet (UV) exposure or other atmospheric conditions may increase the tenacity of the adhesive such that it is no longer easy to remove the item from the supporting surface. Atmospheric or other conditions, to which the adhesive is subjected, may conversely decrease the longevity of the adhesive such that it no longer holds the item in place as desired.

Oftentimes, appliqués are designed to allow for a clean removal by removing the appliqué as one piece. Appliqués for large applications, however, such as markings or decorations on aircraft, are extremely large. Therefore, there is a large surface area which may suffer damage during the time which the appliqué is applied to the surface. This, in turn, reduces the ability to remove the appliqué as one piece, thereby reducing the possibility of a clean removal of the appliqué from the surface.

Additional or supplementary adhesives are often used to hold films in place, in addition to the main adhesive layer. For example, an edge sealant may be applied to the front surface of a film to ensure that the edge does not become loosened over a period of time, even though the majority of the adhesive on the back of the film may still remain in place. Furthermore, these edge treatments or adhesives are commonly used because of the designed lack of strength of the main or primary adhesive to hold the film, due to the need to be able to remove the film in the future.

Therefore, it is desired to provide an adhesive which will allow for easy removal of a film at a desired time. The adhesives will also be cleanly and substantially completely removed from the surface with the film. It is desired that this adhesive be particularly strong so that other treatments, such as edge treatments or sealants, need not be used because the adhesive on the film itself is strong enough to hold the film in place. Furthermore, it is desired that the adhesive be strong enough to allow for generally impervious adhesion of the film to the substrate regardless of the conditions to which the film is exposed. Nevertheless, the film still needs to be readily removable when desired, and only when desired. Therefore, it is desired that the adhesive includes not only the strength and longevity of very strong adhesives, but also includes the ability to be removed easily without resorting to special chemicals.

### SUMMARY OF THE INVENTION

The adhesive system of the present invention allows for a strong adhesion of a member, including a structural support, a film or other appliqué, to a substrate while also allowing for easy removal of the member at a predetermined time. The member is affixed to a substrate with an adhesive, where the adhesive includes a releasing agent or constituent. The releasing agent allows for a substantially clean removal of the adhesive and easy removal of the member at a desired time in the future due to the application or presence of a particular catalyst. For example, a micro-balloon containing a gas may be included in the adhesive, which is activated by heat, such that it will expand and push off the film for easier removal by an operator.

A first embodiment of the present invention includes an adhesive layer to form a bond between a film and a substrate. The adhesive layer includes an adhesive agent that is curable to form the bond between the film and a surface of the substrate. A releasing agent is dispersed in the adhesive layer that is selectively activated to weaken the bond between the film and the surface. When the releasing agent is activated the film may be substantially removed from the substrate.

A second embodiment of the present invention includes a system able to allow for the substantial removal of a film that is bonded to a substrate. The film of the system includes a generally deformable sheet. The substrate includes a surface to which the film is bondable. An adhesive is placed between the film and the substrate to substantially form a bond between the film and the surface. A releasing agent is dispersed in the adhesive and is selectively activated to substantially remove the bond between the film and the surface.

The present invention provides for a novel method of bonding a film to a surface of a substrate such that the film is selectively removable. An adhesive selectively bonds the film to the surface. A releasing agent is dispersed in the adhesive. The film is then bonded to the surface with the adhesive such that the film is substantially affixed to the surface. An additional feature of the invention is that releasing agent may be activated such that the releasing agent substantially destroys the bond between the film and the surface.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of a film adhered to a substrate including a releasing agent according to a first embodiment of the present invention;

FIG. 2 is a cross-sectional view where the releasing agent has been activated according to the first embodiment of the present invention;

FIG. 3 is a cross-sectional view where the releasing agent is provided only in one thin layer in a multilayer adhesive; and

FIG. 4 is a cross-sectional view of a component bonded to a surface where a portion of an adhesive is covering the exterior of the component and where all portions of the adhesive include releasing agent.

### DETAILED DESCRIPTION OF THE PREFERRED EMBODIMENTS

The following description of the preferred embodiment(s) is merely exemplary in nature and is in no way intended to limit the invention, its application, or uses. It will also be understood that the figures relating to the various embodiments are schematic and representative only. They are not meant to be to scale either real or relative. The layer thicknesses are illustrative only to better understand the invention. Moreover, although the following discussion relates to examples including adhering films to a substrate it will be understood that other items may be affixed to a substrate with the adhesives of this invention.

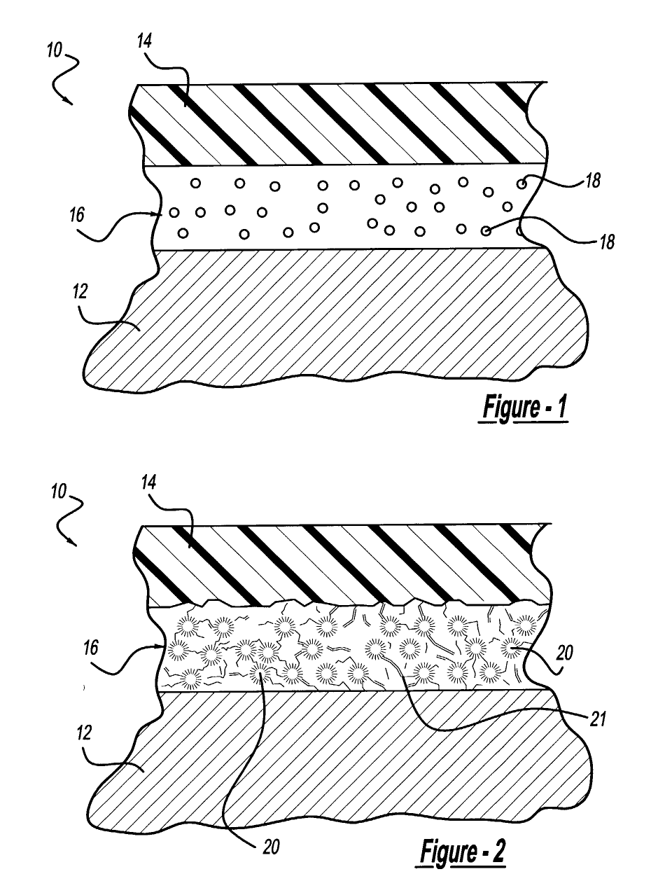

An adhesive release system 10 is illustrated in FIG. 1. The system 10 generally includes a substrate 12 to which component or member, in this example a film 14, is bonded. The film 14 may include an appliqué or decal and is adhered using an adhesive layer 16. Exemplary films and appliqués include the following:

U.S. Pat. No. 6,417,253 entitled “Color Stable Compositions Containing Arylate-Comprising Polymers”;

U.S. Pat. No. 6,177,189 entitled, “Appliqués Providing Corrosion Protection”; U.S. Pat. No. 5,965,256 entitled, “Protective Films and Coatings”;

U.S. Pat. No. 5,824,391 entitled, “Appliqués To Eliminate Painted Coatings On Surfaces Having Complex Curvature”;

U.S. Pat. No. 5,660,667 entitled, “Method Of Coating Surfaces Using Appliqués Of Constant Gaussian Curvature”;

U.S. Pat. No. 5,580,819 entitled, “Coating Composition, Process For Producing Antireflective Coatings, And Coated Articles”;

U.S. Pat. No. 5,133,516 entitled, “Drag Reduction Article”;

U.S. Pat. No. 5,069,403 entitled, “Drag Reduction Article”;

U.S. Pat. No. 4,986,496 entitled, “Drag Reduction Article”;

PCT Publication No. WO 99/65674 entitled, “Edge Seal and Sealing methods for Appliqués”;

each incorporated herein by reference.

The adhesive layer 16 substantially permanently, but selectively, affixes the film 14 to the substrate 12. The film 14 is also selectively removable such that it is not easily or readily removed from the substrate 12 unless it is desired to be removed by an operator.

The adhesive layer 16 may include an adhesive appropriate for the particular application. Furthermore, when the adhesive layer 16 includes a releasing agent 18, the adhesive layer 16 may include an adhesive agent which is particularly strong. The adhesive agent may include solvent bound organic molecules which form the bonds between the film 14 and the substrate 12 after the solvent has evaporated. Particular formulations for the releasing agent 18 are generally known in the art and include, for example, Expancel® 810 DU produced by Expancel, Inc., especially for temporary coatings on aircraft support equipment. With the use of the present invention, especially strong adhesive agents may be used due to the inclusion of the releasing agent 18.

The adhesive layer 16 further includes a releasing agent 18. The releasing agent 18 may include micro-balloons, blowing agents or chemicals, or solvents. The releasing agent 18 allows for removal of the film 14 at a predetermined point in the future. Generally, the releasing agent 18 only allows removal of the film 14 when a particular condition or catalyst is applied to the adhesive layer 16 through or around the film 14. The releasing agent 18 can act in several ways including expanding to push the film 14 away from the substrate 12. Only when it is activated does the releasing agent 18 allow for a destruction or expansion of the adhesive layer 16 between the film 14 and the substrate 12.

The film 14 may include generally known items. For example stickers, masking tape, decorative striping, or large appliqués for applications such as aircraft may be included as the film 14. These films 14 are generally formed of polymers set to form the film 14. The film 14 may also include an ink or marking layers. For example, a large decal appliqué may be placed on an aircraft exterior to signify the trade name or origin of the aircraft. The appliqués for aircraft are relatively large since they must cover a substantial portion of the exterior surface of an aircraft. Other examples include masking tape which may be used in modern construction and domestic use. The masking tape is generally applied with the intent to remove it completely at a predetermined future time. It will be appreciated that the present invention, however, is not limited to films or appliqués, but may comprise virtually any component or object capable of being secured to a substrate or other like supporting component.

The system 10 advantageously allows for easy removal of the film 14 when the releasing agent 18 is activated. As illustrated particularly in FIG. 2, the activated releasing agent 20 substantially destroys portions of the adhesive layer 16. In addition, the activated releasing agent 20 can push the film 14 away from the substrate 12, thus beginning the process of removing the film 14.

One exemplary process, as illustrated in FIG. 2, provides micro-balloons as the releasing agent 18. The micro-balloons 18 are generally activated by a heat source. As the micro-balloons 18 increase in temperature, the gas contained within the micro-balloons 18 expands. As the gas within the micro balloon 18 expands the micro-balloons 18 become the activating releasing agent 20. At this point, the gas continues to expand destroying the bonds of the adhesive layer 16 by producing a plurality of voids and cracks 21. As the cracks 21 and voids are produced, the pressure within the adhesive layer 16 is increased and a pressure between the film 14 and the substrate 12 is also increased. When this happens, the pressure destroys the bond of the adhesive layer 16 between the substrate 12 and the film 14, thereby loosening the film 14. In addition, the film 14 is physically pushed away if portions of the activated releasing agent 20 are sufficiently close to the under surface of the film 14.

Many items may be utilized as the releasing agent 18. For example, micro-balloons may be used as the releasing agent 18. Generally, a micro-balloon will include a small encapsulated volume of gas or liquid. The micro-balloons are disbursed in the adhesive layer 16 when the adhesive layer 16 is either applied to the substrate 12 or when the film 14, with the adhesive layer 16, applied thereto is applied to the substrate 12. When the micro-balloons are heated they expand, thereby increasing the pressure between the film 14 and the substrate 12. Various heat sources may provide the appropriate degree of heat for activating the micro-balloons. Such heat sources may include flash lamps, hot water, infrared light, or even a hair dryer for a more domestic use.

During a removal procedure, as the micro-balloons are heated, the gas inside each micro-balloon expands, thereby destroying the bond of the adhesive layer 16. The micro-balloon may be changed for different applications to react to a specific temperature to give greater control over its activation. After this occurs, the film 14 is substantially loosened from the substrate 12 and may be easily removed. In addition, the adhesive layer 16 is also substantially destroyed and can therefore be more easily removed from the substrate 12.

Other releasing agents 18 include blowing agents. Blowing agents are chemically activated constituents which produce a gas when activated. One exemplary blowing agent includes Celogen® blowing agent 765A which may be obtained from Uniroyal Chemical Company, Inc. The blowing agent generally evolves or releases a gas when catalyzed by particular catalysts. Therefore, even though the blowing agent can evolve a gas, it will only evolve the gas when catalyzed at a predetermined point in the future. The blowing agent may also be catalyzed by heat or a chemical catalyst. In any case, when the blowing agent is activated it produces pressure between the film 14 and the substrate 12, such that the film 14 is substantially pushed away from the substrate 12. This also allows for easy removal of the film 14 from the substrate 12 only at a predetermined point when the blowing agent is activated.

Another example of the releasing agent 18 includes a solvent. The solvent is applied in a neutral state in the adhesive layer 16, but may be activated by a heat or a chemical catalyst. Therefore, the simple addition of this catalyst changes the neutral solvent to an activated form. When activated, the solvent dissolves the adhesive layer 16 allowing for easy removal of the film 14 from the substrate 12.

Therefore, the present invention allows for easy removal of the film 14 from the substrate 12. Because the film 14 may be easily removed, even stronger adhesives may be used in the adhesive layer 16, where weak adhesives were previously used because of the need for easy removal of the film 14. Because of the releasing agent 18, a stronger adhesive can be used which does not decrease the ability to remove the film 14 from the substrate 12 at a predetermined point in the future.

Furthermore, the releasing agent 18 allows for a substantially clean removal of the adhesive layer 16 and the film 14 from the substrate 12. Because the releasing agent 18 is dispersed throughout the adhesive layer 16, substantially all of the adhesive layer will be affected by the releasing agent 18. This allows for a substantially complete destruction of the bond formed by the adhesive layer 16 between the film 14 and the substrate 12. When this occurs, substantially no bond is left to hold the film 14 to the substrate 12.

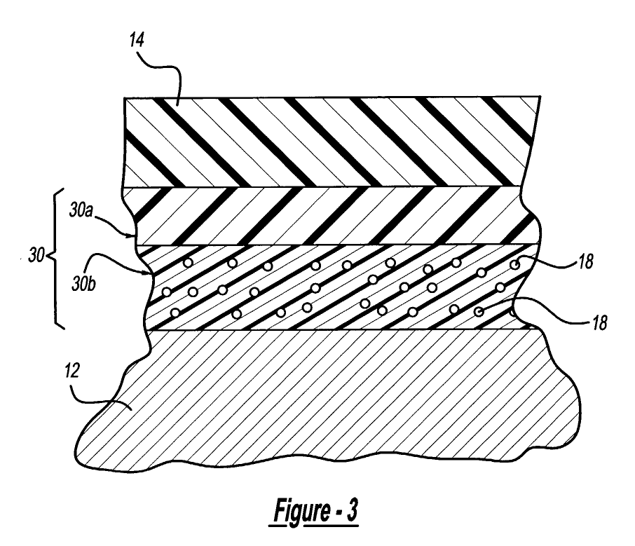

The releasing agent 18 may also be precisely placed in the adhesive layer 16 to remove substantially the entire adhesive layer 16. Although the activated releasing agent 20, as illustrated in FIG. 2, is substantially evenly distributed throughout the adhesive layer 16, the distribution may be more controlled by controlling the placement of the releasing agent 18. With reference to FIG. 3, where like numerals reference like items from above, a substantial portion of an adhesive layer 30 may be removed with the film 14. The adhesive layer 30 may be applied as several layers to either the film 14 or the substrate 12. The adhesive layer 30 may be applied including a first adhesive layer 30a and a second adhesive layer 30b. The releasing agent 18 is provided only in the second adhesive layer 30b, the layer placed closest to the substrate 12. Therefore, the releasing agent 18 may be placed substantially closer to the substrate 12 than to the film 14. When the releasing agent 18 is concentrated near the substrate 12, activating the releasing agent 18 pushes away the film 14 and a substantial portion of the first adhesive layer portion 30a as well. Due to this, a clean and complete removal of the film 14 and the adhesive layer 30 may more easily occur. Alternatively, the releasing agent 18 may be concentrated in the layer of the multi-layer adhesive 30 which is closer to the film 14. This may be desired when the adhesive is being applied to a difficult to bond substrate or when the releasing agent 18 may interfere with a strong bond between the adhesive layers 30 and the substrate 12.

The complete removal of the adhesive layer 16 or 30 is particularly relevant when large films 14 are applied to weight sensitive structures such as aircraft. Because weight is a paramount concern for aircraft, and weight reduction is highly desirable, the use of releasing agent 18 can ensure the substantial removal of the entire adhesive layer 16 or 30 and film 14. Therefore, when the film 14 and the adhesive layer 16 or 30 are removed from the substrate 12, which in this example is an aircraft, it is assured that substantially no residue is left to increase the weight of the aircraft.

Although the above description exemplarily describes adhering the film 14 to the substrate 12 with the adhesive layer 16, 30, it will be understood that other members or components may be affixed to the substrate 12 other than the film 14. For example, a structural component may be adhered to the substrate 12 using the adhesive layer 16, 30. In addition, other components and portions may be affixed to the substrate 12 which are neither films or structural components, such as panels and facades. Therefore, it will be understood that the adhesive removal system 10 including the adhesive layers 16, 30 may be used to affix any component, member, film, or applique to the substrate 12. In addition, other less industrial applications include using the adhesive layer 16, 30 to affix items such as wallpaper to walls or other surfaces.

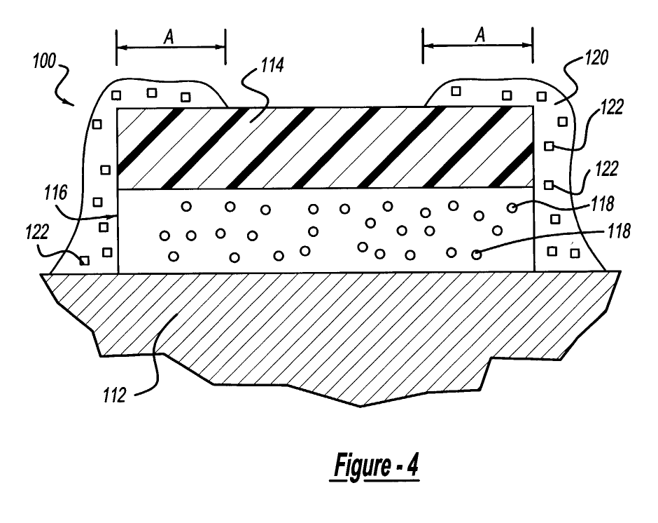

With reference to FIG. 4 an adhesive release system 100 according to an alternative embodiment is illustrated. The adhesive release system 100 includes a substrate 112 to which a film 114 is adhered with an adhesive layer 116. Dispersed in the adhesive layer 116 is a releasing agent 118. The releasing agent 118 and the material of the adhesive film 116 may be any of the afore mentioned releasing agents 18 or adhesive layers 16. Covering a portion A of the film 114 is an exterior adhesive layer 120. Generally, the exterior adhesive layer is an edge sealant that seals an edge of the film 114. Dispersed in the exterior adhesive layer 120 is an exterior releasing agent 122. The exterior releasing agent 122 may the same or different than the releasing agent 118. Moreover, the exterior releasing agent 122 may be activated at the same time or a different time than the releasing agent 118.

Therefore, although the previously-described examples include placing the adhesive layer 16, 30 between the film 14 and the substrate 12, it will be understood that the exterior adhesive layer 120, including the exterior releasing agent 122, may be placed on the exterior of the film 114. For example, the exterior adhesive layer 120 may be used as an edge sealant which is painted over the edge of the film 114 and onto the substrate 112 to assist in sealing the edges and resisting pull away or peel off initiating at the edge of the film 114. It will also be understood that the exterior adhesive layer 120 may be placed on the exterior of other elements and is not limited solely to films.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An adhesive for forming a bond between a component and a substrate, comprising:
an adhesive agent that forms a bond between said component and a surface of the substrate; and
a releasing agent that is selectively activated to weaken the bond, wherein when said releasing agent is activated said component is removable from the substrate.

2. The adhesive of claim 1, wherein said adhesive agent substantially permanently affixes said component to said surface.

3. The adhesive of claim 1, wherein said releasing agent includes a capsule containing a volume of gas; and
wherein said releasing agent is activated when heated to a predetermined temperature such that said volume of gas expands, thereby expanding said capsule and weakening the bond between said component and said surface.

4. The adhesive of claim 3, wherein said capsule includes a micro-balloon.

5. The adhesive of claim 1, wherein said releasing agent includes a constituent able to evolve a gas when activated, such that said gas expands to weaken the bond between said component and said surface.

6. The adhesive of claim 1 wherein:
said adhesive agent is selected from a group consisting of pressure sensitive adhesives, curable adhesives, and mixtures thereof.

7. The adhesive of claim 1, wherein said releasing agent includes a constituent selectively changeable between a neutral form and an activated form, wherein in said activated form said releasing agent dissolves said adhesive agent.

8. A system able to allow for the substantial removal of a component that is bonded to a substrate, comprising:
an adhesive placed between said component and the substrate to substantially form a bond between said component and the substrate;
a releasing agent dispersed in said adhesive;
wherein said releasing agent is selectively activated to substantially eliminate the bond between said component and the substrate to thereby enable ready removal of said component from the surface; and
wherein said component includes a generally deformable sheet.

9. The system of claim 8, wherein said releasing agent includes a capsule containing a volume of gas; and
wherein said capsule is activated when heated to a predetermined temperature, thereby causing said volume of gas to expand said capsule, thereby weakening said bond between said component and the substrate.

10. The system of claim 9, wherein said capsule includes a micro-balloon.

11. The system of claim 8, wherein said component includes a polymer formed into said deformable sheet.

12. The system of claim 8, wherein said adhesive agent substantially permanently affixes said component to the substrate.

13. The system of claim 8, wherein said releasing agent includes a constituent able to evolve a gas when activated, such that said gas expands to weaken said bond between said component and the substrate.

14. The system of claim 13, wherein said constituent includes a chemical.

15. The system of claim 8, wherein said releasing agent includes a constituent selectively changeable between a neutral form and an activated form, such that said activated form dissolves said adhesive agent.

16. The system of claim 8, further comprising:
an edge sealant adapted to be placed on the exterior of said component;
an edge sealant releasing agent dispersed in said edge sealant;
wherein said component includes an exterior and said edge sealant is placed on the exterior of said component to assist in the bond between an edge of said component and the substrate.

17. The system of claim 16, wherein said edge sealant releasing agent is activated when said releasing agent is selectively activated.

18. A method of bonding a component to a surface of a substrate such that the film is selectively removable, comprising:
providing an adhesive which is adapted to selectively bond said component to the surface;
dispersing a releasing agent in said adhesive; and
selectively bonding said component to the surface, such that said component is substantially affixed to the surface.

19. The method of claim 18, further comprising:
activating said releasing agent such that said releasing agent substantially destroys the bond between said component and the surface.

20. The method of 18, wherein said component includes a polymer formed into a flexible sheet.

21. The method of claim 18, wherein said releasing agent includes a capsule containing a volume of gas, wherein said capsule is activated when heated to a predetermined temperature such that said volume of gas expands said capsule, thereby weakening said bond between said component and said surface.

22. The method of claim 21, wherein said capsule includes a micro-balloon.

23. The method of claim 18, wherein said releasing agent includes a constituent able to evolve a gas when activated, such that said gas expands to weaken said bond between said component and said surface.

24. The method of claim 18, wherein said releasing agent includes a constituent selectively changeable between a neutral form and an activated form, such that said activated form dissolves said adhesive.

25. The method of claim 18, wherein disposing said releasing agent in said adhesive includes generally uniformly dispersing said releasing agent in said adhesive.

26. The method of claim 18, wherein providing an adhesive which is adapted to selectively bond said component to the surface includes:
disposing said adhesive on an exterior of at least a portion of said component.
